(19) United States
(12) Patent Application Publication
(10) Pub. No.: US 2026/0001341 A1
(43) Pub. Date: Jan. 1, 2026

(54) CONTAINER FOR LIQUID CARTRIDGE, LIQUID CARTRIDGE CONTAINER, AND MANUFACTURING METHOD FOR LIQUID CARTRIDGE CONTAINER

(71) Applicant: CANON KABUSHIKI KAISHA, Tokyo (JP)

(72) Inventors: HIROSHI KOSHIKAWA, Kanagawa (JP); TATSUO NANJO, Kanagawa (JP); SOJI KONDO, Kanagawa (JP); KEISUKE IINUMA, Kanagawa (JP); HIROSHI YAMADA, Kanagawa (JP)

(21) Appl. No.: 19/247,290

(22) Filed: Jun. 24, 2025

(30) Foreign Application Priority Data
Jun. 28, 2024 (JP) 2024-104682

(51) Int. Cl. B41J 2/175

(52) U.S. Cl. CPC B41J 2/17533; B41J 2/17536; B41J 2/17559

(57) ABSTRACT

A container that stores a liquid cartridge to be attached to a liquid ejection apparatus includes a container main body provided with a storage portion including a space in which the liquid cartridge is stored and a flange portion configured to form an opening through which the liquid cartridge is stored in the storage portion, and a lid configured to cover the opening, wherein the flange portion has a surface facing the lid and includes, on the surface, a first rib configured to be welded to the lid and arranged surrounding the opening, and a plurality of second ribs configured to be welded to the lid and located closer to the opening than the first rib.

### BACKGROUND

### Field of the Technology

The present disclosure relates to a container for a liquid cartridge, a liquid cartridge container, and a manufacturing method for the liquid cartridge container.

### Description of the Related Art

An ink-jet recording apparatus serving as a liquid ejection apparatus that ejects liquid such as ink from a liquid ejection head to perform desired recording is equipped with an ink tank for storing ink and a liquid ejection head for ejecting the ink stored in the ink tank. There is a type of ink-jet recording apparatus to which a liquid cartridge such as an ink cartridge, which is an ink tank formed into a cartridge, and a liquid ejection head cartridge, which is a liquid ejection head formed into a cartridge, are separately attached. There is also a type of ink-jet recording apparatus to which an ink cartridge with a liquid ejection head, in which an ink tank and a liquid ejection head are integrated into a cartridge, is attached.

A liquid cartridge with a liquid ejection head is stored in a container for an ink cartridge with a liquid ejection head after a seal or the like is applied to an ink ejection port of the liquid ejection head. A blister pack is often used also as a container for an ink cartridge with a liquid ejection head.

A container for a liquid cartridge with a liquid ejection head discussed in Japanese Patent Application Laid-Open No. 2022-29848 is provided with a main body that includes an opening portion on a surface facing a bottom surface and a holding portion that holds the liquid cartridge therein. Further, according to Japanese Patent Application Laid-Open No. 2022-29848, a configuration is discussed in which the opening portion is sealed with a lid.

### SUMMARY

The present inventors have found that because of increased weight due to larger ink cartridge capacity and decreased welding strength between a container main body and a lid due to use of recycled plastic such as a post-consumer recycled (PCR) material for the container in order to address environmental issues in recent years, if the ink cartridge, which is a stored item, is dropped, it may impact the lid and cause a welded part between the container main body and the lid to partially peel off.

On the other hand, if the welding strength between the container main body and the lid is made too strong in order to prevent the lid from peeling off, it may become difficult to open the lid to take the ink cartridge out from a storage portion.

According to some embodiments, a container that stores a liquid cartridge to be attached to a liquid ejection apparatus includes a container main body provided with a storage portion including a space in which the liquid cartridge is stored and a flange portion configured to form an opening through which the liquid cartridge is stored in the storage portion, and a lid configured to cover the opening, wherein the flange portion has a surface facing the lid and includes, on the surface, a first rib configured to be welded to the lid and arranged surrounding the opening, and a plurality of second ribs configured to be welded to the lid and located closer to the opening than the first rib.

Further features of the present disclosure will become apparent from the following description of exemplary embodiments with reference to the attached drawings.

### BRIEF DESCRIPTION OF THE DRAWINGS

FIGS. 1A and 1B are perspective views of a cartridge stored in a container according to an exemplary embodiment.

FIG. 2 is a perspective view illustrating a state in which the cartridge is stored in a container main body according to the exemplary embodiment.

FIG. 3 is a top view illustrating a state in which the cartridge is stored in the container main body.

FIG. 4 is a partial enlarged cross-sectional view of the container main body before a lid is welded according to the exemplary embodiment.

FIG. 5 is a partial enlarged cross-sectional view of the container main body after the lid is welded according to the exemplary embodiment.

FIG. 6 is a cross-sectional view of a storage body after the lid is welded according to the exemplary embodiment.

FIG. 7 is a top view of the storage body and a peeling load measurement result according to the exemplary embodiment.

FIG. 8 is a manufacturing flow diagram of the storage body according to the exemplary embodiment.

FIG. 9 is a cross-sectional view of a storage body in which a cartridge is stored according to a comparative example.

FIG. 10 is a perspective view illustrating a state in which the cartridge is stored in a container main body according to the comparative example.

### DESCRIPTION OF THE EMBODIMENTS

Various exemplary embodiments, features, and aspects for implementing the present disclosure will be described in detail with reference to the attached drawings. Constituent components described in the following exemplary embodiments can be appropriately modified in their dimensions, materials, shapes, and relative layout depending on a configuration and various conditions of an apparatus to which the present disclosure is applied. In other words, it is not intended to limit the scope of the present disclosure only to the following exemplary embodiments.

A container according to the following exemplary embodiment is a container for a liquid ejection head in which the liquid ejection head is stored in a case where the liquid ejection head is distributed in the market. According to the present exemplary embodiment, a container for a liquid ejection head is described, but an object to be stored in the container is not limited to a liquid ejection head. For example, an object to be stored may be a container that stores a liquid cartridge for replenishing liquid into a liquid ejection head (ink-jet head) provided in an ink-jet printer or a liquid cartridge that includes a liquid ejection head.

In the following descriptions, in a state where a liquid cartridge is attached to a liquid ejection apparatus, a height direction of the liquid cartridge is defined as a Z direction. A width direction of the liquid cartridge perpendicular to the Z direction is defined as an X direction. A depth direction of the liquid cartridge perpendicular to the X and Z directions is defined as a Y direction.

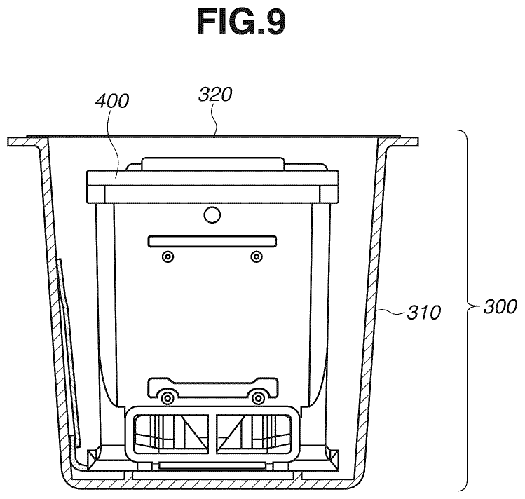

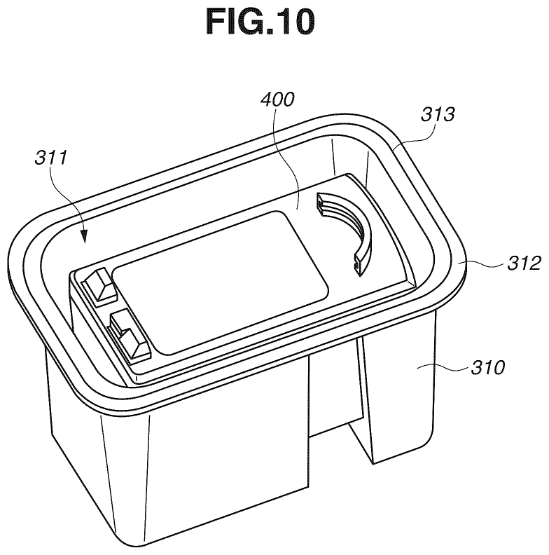

A basic configuration of a liquid cartridge container according to a comparative example is described with reference to FIGS. 9 and 10. FIG. 9 is a cross-sectional view illustrating the liquid cartridge container according to the comparative example. A blister pack 300 serving as a container includes a blister container 310 serving as a container main body provided with an opening through which a cartridge 400 is inserted and a lid 320 for sealing the opening. The cartridge 400 is stored inside the blister pack 300, and thus the liquid cartridge container is formed. FIG. 10 is a perspective view illustrating a state in which the cartridge 400 is stored in the blister container 310 through the opening of the blister container 310. The blister container 310 includes a storage portion 311 for storing the cartridge 400 and a flange portion 312 that forms the opening portion of the blister container 310 and is welded to the lid 320 via a welding rib 313. The welding rib 313 is provided over an entire circumference of a surface of the flange portion 312.

The blister container 310 and the lid 320 are welded together by melting and bonding the welding rib 313 using a heating unit such as a heating horn. The welding rib 313 is provided over the entire circumference of the flange portion 312 to surround the opening portion and thus can hermetically seal the inside of the blister container 310. Accordingly, it is possible to suppress evaporation of stored liquid from the cartridge 400 and prevent a foreign substance from entering the cartridge 400 from the outside in a distribution environment or the like.

On the other hand, the present inventors have found through the study that following issues are likely to occur because of increased weight due to larger liquid cartridge capacity and decreased welding strength due to use of recycled plastic such as a post-consumer recycled (PCR) material for a blister container in order to address environmental issues. In a case where the blister container 310 is dropped with the flange portion 312 or the lid 320 facing downward or the like, a protrusion portion of the cartridge 400 may impact the lid 320 and cause a part of a welded portion between the blister container 310 and the lid 320 to peel off. As a measure against peeling of the welded portion, it is possible to increase a width of the welding rib 313 or to provide a double welding rib 313 instead of a single welding rib 313 to increase a welded area so that the welding strength can be improved. However, if the welding strength is too high, it may become difficult to peel off the lid 320 from the blister container 310 to take out the cartridge 400.

An example of an exemplary embodiment of the present disclosure is described with reference to the attached drawings.

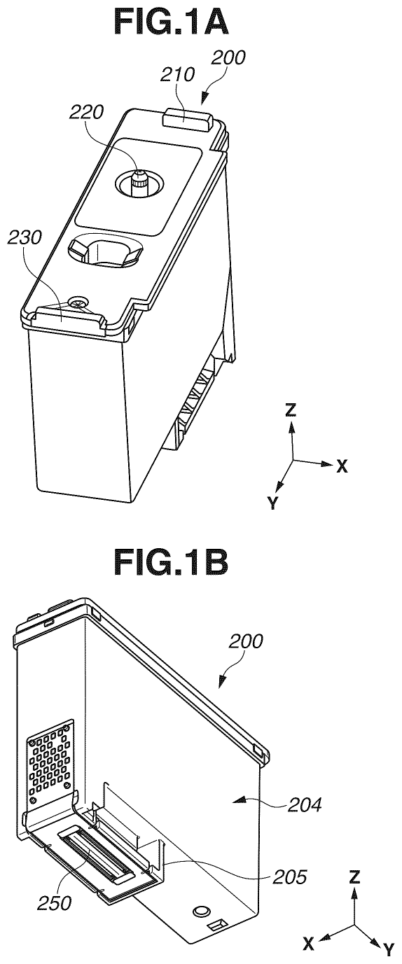

FIGS. 1A and 1B are perspective views of a cartridge 200 according to the present exemplary embodiment. The cartridge 200 includes an ejection substrate (ejection port substrate) 250 including an ejection port on its lower portion in a state where a liquid ejection apparatus is used. In other words, the cartridge 200 is a liquid cartridge integrated with a liquid ejection head. The cartridge 200 includes three protrusions on its upper portion, namely a protrusion portion 210 for identifying liquid stored therein by matching with a structure of the liquid ejection apparatus, a pin 220 for positioning the cartridge 200 in the liquid ejection apparatus, and a gripping portion 230 used to attach the cartridge 200 to the liquid ejection apparatus. FIG. 1A is the perspective view of the cartridge 200 as viewed from a side opposite to the ejection substrate 250, and FIG. 1B is the perspective view of the cartridge 200 as viewed from the ejection substrate 250.

An ink reservoir chamber 204 is filled with an absorbing member that keeps ink.

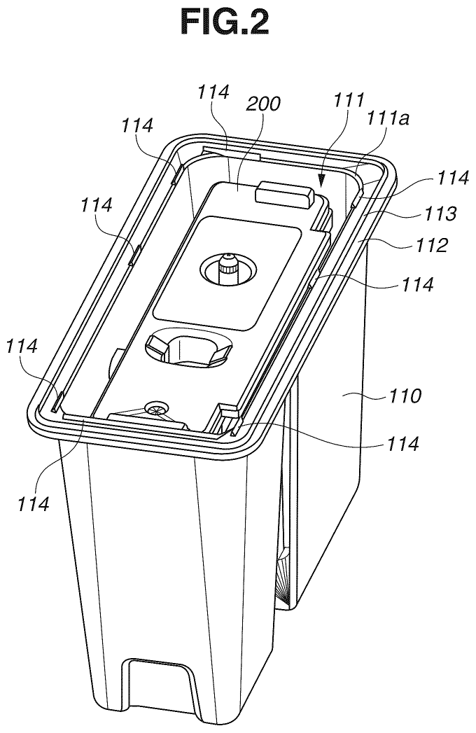

FIG. 2 is a perspective view illustrating a state in which the cartridge 200 is stored in the container according to the present exemplary embodiment before a lid 120 is welded to a blister container 110. A storage portion 111 included in the blister container 110 as the container main body stores the cartridge 200 as a stored item therein. The blister container 110 includes a flange portion 112 serving as an opening peripheral portion that forms an opening 111a through which the stored item is inserted into and taken out from the storage portion 111.

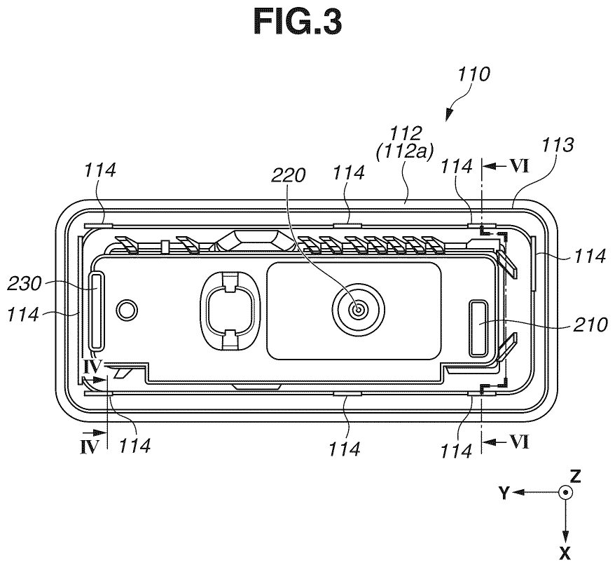

FIG. 3 is a top view of the blister container 110 as viewed from the flange portion 112. Similar to the comparative example illustrated in FIG. 9, the blister container 110 includes a first welding rib 113 provided over an entire circumference of a surface 112a of the flange portion 112 facing the lid 120. The first welding rib 113 is a protrusion provided on the surface 112a. In addition to the first welding rib 113, according to the present exemplary embodiment, second welding ribs 114 are provided discontinuously at eight locations on the surface 112a of the flange portion 112 closer to the storage portion 111 than the first welding rib 113 when viewed in a direction perpendicular to the surface 112a of the flange portion 112. In other words, it can be said that the second welding ribs 114 are ribs arranged closer to the opening (the opening 111a) than the first welding rib 113. The second welding ribs 114 are protrusions provided on the surface 112a, similar to the first welding rib 113. The second welding ribs 114 are provided near the three protrusions (the protrusion portion 210, the pin 220, and the gripping portion 230) of the cartridge 200 described above. Accordingly, it is possible to increase a total welded area between the blister container 110 and the lid 120 near the protrusions and to locally increase the welding strength. For this reason, even if a storage body 1000 for the cartridge is dropped in a state in which the flange portion 112 faces downward, it is possible to prevent the protrusions included in the cartridge 200 from impacting the lid 120 and causing the first welding rib 113 between the blister container 110 and the lid 120 to peel off. Since the second welding ribs 114 are not provided over the entire circumference of the flange portion 112, the welding strength is prevented from becoming too strong.

The cartridge 200 is stored in the storage portion 111, and then the lid 120 is bonded to the flange portion 112, so that a sealed space is formed. Bonding portions between the welding ribs (the first welding rib 113 and the second welding ribs 114) of the blister container 110 and the lid 120 are sealed by heat sealing, but other bonding methods may be used. According to the present exemplary embodiment, an example of a material of the lid 120 includes a laminate film made of a polyethylene terephthalate (PET) resin and polypropylene (PP). Polypropylene (PP) is used as a material of the blister container 110 including the welding ribs. The materials of the lid 120 and the blister container 110 are not limited to those described above.

Recycled plastic can be used as a material of the lid 120 and the blister container 110. A term “recycled plastic material” described in the present disclosure is used in a broad sense to include a PCR material and a pre-consumer recycled material. A recycled plastic material is made from raw materials that have experienced some degree of deterioration due to a thermal history during molding, and stress, heat, light, solvents, and the like during use. Due to these circumstances, a recycled plastic material is known to have different physical properties from those of a virgin material. For example, a recycled plastic material tends to have a poorer shock absorbing capacity, in which molecular chains inside the material bend to absorb a force when an impact is applied. This tendency can be confirmed by the Charpy impact test, and a molding material containing a recycled plastic material indicates lower impact strength than that of a virgin material. The deterioration in the shock absorbing capacity is due to a fact that original molecular chains have been cut by the above-described deterioration, and the shock absorbing effect of the molecular chains is reduced.

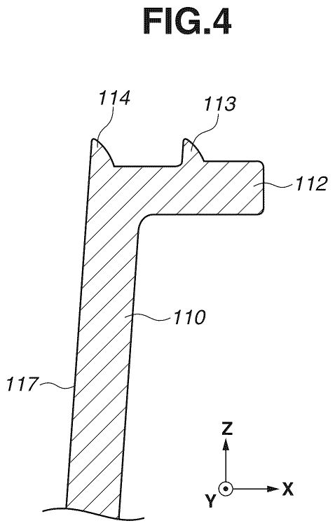

FIG. 4 is an enlarged cross-sectional view taken along a line IV-IV in FIG. 3 illustrating the first welding rib 113 and the second welding rib 114 provided on the surface 112a of the flange portion 112 before they are welded to the lid 120. The first welding rib 113 and the second welding rib 114 (hereinbelow, both are also collectively referred to as “welding ribs”) both have, with respect to a cross-sectional shape on a straight line perpendicular to a longitudinal direction, a curved shape such as an R shape on an outer side (a right side in the drawing) and a linear shape inclined with respect to the surface of the flange portion 112 on an inner side (closer to the storage portion, and a left side in the drawing).

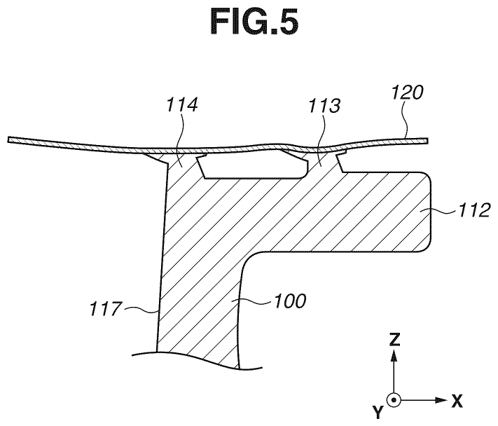

FIG. 5 is an enlarged cross-sectional view illustrating a state after the lid 120 is welded to the blister container 110. As the shapes of the welding ribs after welding, the first welding rib 113 and the second welding rib 114 each have an obtuse angle in the cross-sectional shape at a boundary between the lid 120 and the welding rib on the inner side (the left side in the drawing).

In contrast, on the outer side (the right side in the drawing), the R shape before welding changes to a wedge shape by welding the welding rib to the lid 120, and the cross-sectional shape of the welding rib at the boundary between the lid 120 and the welding ribs has an acute angle. Accordingly, the welding strength between the lid 120 and the welding rib is strong enough to withstand a force applied to peel the lid 120 from the inside of the blister container 110, whereas in a case where the lid 120 is peeled off from the outside, the force is concentrated at a base of the wedge shape, so that the lid 120 is easily peeled off.

Regarding a height of the welding rib (a height in a direction perpendicular to the surface 112a of the flange portion 112) before welding the lid 120, a height of the first welding rib 113 is slightly greater than a height of the second welding rib 114 as illustrated in FIG. 5. However, a relationship between the heights of the first welding rib 113 and the second welding rib 114 is not limited to the configuration in FIG. 4. For example, in a case where the welding strength of the second welding rib 114 is desired to increase, the height of the second welding rib 114 before welding may be the same as or greater than the height of the first welding rib 113.

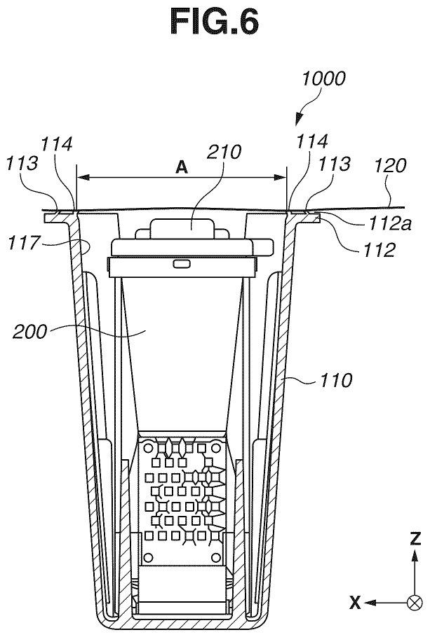

FIG. 6 is a cross-sectional view taken along a line VI-VI in FIG. 3 of the storage body 1000 in a state in which the cartridge 200 is stored in the blister container 110 and the lid 120 is welded. FIG. 6 illustrates a movable range A of the lid 120 that has been welded. In the storage body 1000, the cartridge 200 is stored in a blister pack 100 serving as a container. The blister pack 100 includes the blister container 110 serving as a container main body provided with an opening through which the cartridge 200 is inserted and the lid 120 that seals the opening. In a case where the storage body 1000 is dropped in a state in which the flange portion 112 faces downward, the protrusions (the protrusion portion 210, the pin 220, and the gripping portion 230) provided on the upper portion of the cartridge 200 come into contact with the lid 120 and apply an impact to the lid 120 as described above. Accordingly, the lid 120 largely bends upward in the drawing from the surface 112a of the flange portion 112, and the protrusions also move from the surface 112a toward the lid 120, which is above the surface 112a in the drawing. For example, in a case where the storage body 1000 is stored in an outer packaging box or the like, the protrusions of the cartridge 200 may come into contact with an inner surface of the outer packaging box, and a drop impact from a floor surface or the like may be transmitted directly to the cartridge 200, which may damage the ejection substrate 250 and the like.

In the configuration according to the present exemplary embodiment, the second welding ribs 114 are located on an edge of an extension line of an inner side surface 117 of the blister container 110 that forms the storage portion 111 as illustrated in FIGS. 4 to 6. In other words, the second welding ribs 114 are provided so that side surfaces of the second welding ribs 114 are positioned along the inner side surface 117 of the blister container 110. Accordingly, the movable range A of the lid 120 can be reduced, and a tensile force of the lid 120 can be increased. For this reason, it is possible to minimize the bend of the lid 120 in a case where the storage body 1000 is dropped in a posture in which the surface 112a of the flange portion 112 faces downward, and as a result, it is possible to suppress the protrusions from coming into contact with the outer packaging box and to prevent damage to the ejection substrate 250 and the like.

The arrangement of the second welding ribs 114 is described in more detail below.

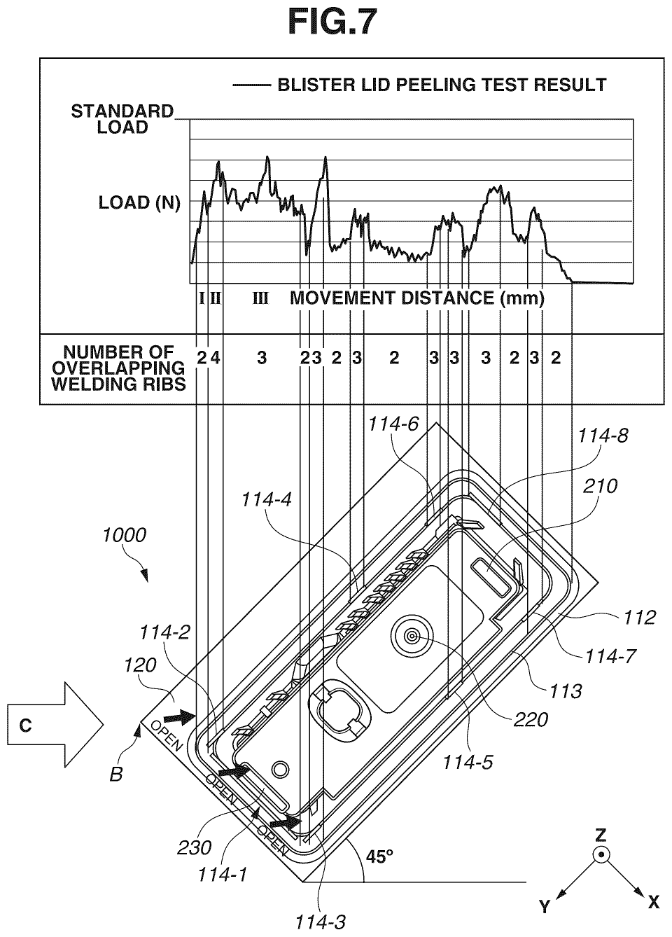

FIG. 7 illustrates the storage body 1000 in which the cartridge 200 is stored in the blister container 110 and the lid 120 is welded, as viewed from the lid 120. According to the present exemplary embodiment, the lid 120 is a transparent film-like member, so that the cartridge 200 can be seen in FIG. 7.

Of a plurality of the second welding ribs 114 illustrated in FIG. 7, the one arranged on a short side of the flange portion 112 near the gripping portion 230 is defined as the second welding rib 114-1, and the one arranged on a short side of the flange portion 112 near the protrusion portion 210 is defined as the second welding rib 114-8. The six second welding ribs 114 arranged on long sides of the flange portion 112 are defined as the second welding ribs 114-2 to 114-7.

In FIG. 7, in order to simulate a process of peeling off the lid 120 in taking out the stored cartridge 200, the blister container 110 is arranged so that its long side forms an angle of 45° with respect to a horizontal direction in the drawing. In addition, FIG. 7 illustrates positions of the second welding ribs 114 in comparison with a peeling load measurement result by a peeling testing machine.

A peeling test of the lid 120 is described. A peeling start point B of the lid 120 is gripped by a gripping portion of the peeling testing machine. Subsequently, the gripping portion is moved at a constant speed in a direction of an arrow indicated on the lid 120 (direction C), so that a movement distance-peeling load curve of the lid 120 is acquired as illustrated in an upper part of FIG. 7.

It is desirable that a total number of overlapping welding ribs (total number of the first welding rib 113 and the second welding ribs 114) included in a direction horizontal to the surface 112a of the flange portion 112 and perpendicular to the peeling direction C at a point in the peeling direction C during the peeling process is three or less, except in an initial peeling process. This is rephrased as follows. When viewed in a direction perpendicular to the surface 112a, a shape of the opening 111a is a substantially rectangular shape having two long sides, two short sides, and four corners. It is desirable that the total number of the first welding rib 113 and the second welding ribs 114 included on a straight line perpendicular to the peeling direction of the lid 120 that intersects with the long side at an angle of 45° is three or less in 90% or more of a distance between two diagonally opposite corners of the substantially rectangular shape in the peeling direction.

Specifically, in a range I at a very beginning of peeling of the lid 120, only the first welding rib 113 overlaps, so that the total number of overlapping is two. In a range II immediately after the range I, the second welding rib 114-1 near the gripping portion 230 and the second welding rib 114-2 located on the long side additionally overlap, so that the total number of overlapping is four. However, because the second welding rib 114-2 according to the present exemplary embodiment is short, approximately 5 mm, and is located near the peeling start point B of the blister, peeling strength does not significantly increase (see the upper portion in FIG. 7). Immediately thereafter, in a range III in which a peeling position passes through the second welding rib 114-2, the total number of overlapping becomes three. After the range III, the total number of overlapping welding ribs remains three or less by devising the arrangement of the second welding ribs 114-3 to 114-7 and the second welding rib 114-8, so that the peeling load can be suppressed to a standard load or less. Accordingly, it is possible to prevent such a situation that the welding strength becomes too high, making it difficult to peel off the lid 120 from the blister container 110 to take out the cartridge 200. At one corner of the flange portion 112, which is the peeling start point of the lid 120, the length of the second welding ribs 114 provided on at least one of the short sides and long sides of the opening 111a is desirably 7.5 mm or less, and more desirably 5.0 mm or less. In other words, it is desirable that at least one of the second welding ribs 114 provided on each of the long and short sides closest to one corner has a length of 7.5 mm or less. Accordingly, the total number of overlapping welding ribs can be three or less, except in the initial peeling process.

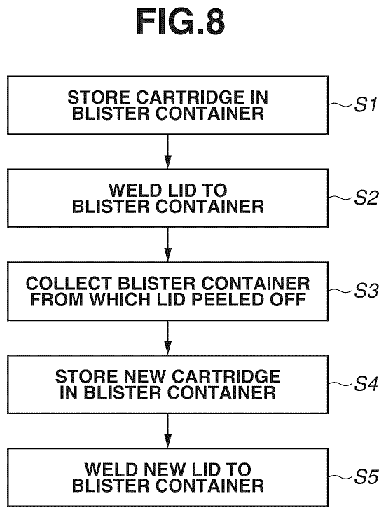

Even after the lid 120 is peeled off from the blister container 110, base portions of the first welding rib 113 and the second welding ribs 114 remain on the surface 112a of the flange portion 112 (see FIG. 5). For this reason, it is possible to manufacture the storage body 1000 in which the blister container 110 is reused, by preparing a new lid 120. FIG. 8 illustrates a manufacturing process flow for the storage body 1000 in which the blister container 110 is also reused. In step S1, the cartridge 200 is stored in the blister container 110, and in step S2, the lid 120 is welded to the blister container 110, so that the cartridge storage body 1000 is manufactured. Subsequently, in step S3, the blister container 110, from which the cartridge 200 has been taken out and the lid 120 has been peeled off, is collected. In step S4, a new cartridge 200 is stored in the collected blister container 110, and in step S5, a new lid 120 is welded, so that the storage body 1000 for the cartridge in which the blister container 110 is reused is manufactured.

In step S3 of collecting the blister container 110, if the blister container 110 is collected in a state in which the used cartridge 200 is stored, the cartridge 200 can be also recycled and reused. Particularly, in collection of the cartridge 200 with the ejection substrate 250, the use of the blister container 110 of the container according to the present disclosure makes it easier to reduce damage to a head portion 205 and the ejection substrate 250 during collection.

According to the present disclosure, both prevention of peeling off of a lid and appropriate strength for opening the lid can be achieved in a container for a liquid cartridge.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-104682, filed Jun. 28, 2024, which is hereby incorporated by reference herein in its entirety.

What is claimed is:

1. A container that stores a liquid cartridge to be attached to a liquid ejection apparatus, the container comprising:
a container main body provided with a storage portion including a space in which the liquid cartridge is stored and a flange portion configured to form an opening through which the liquid cartridge is stored in the storage portion; and
a lid configured to cover the opening,
wherein the flange portion has a surface facing the lid and includes, on the surface,
a first rib configured to be welded to the lid and arranged surrounding the opening, and
a plurality of second ribs configured to be welded to the lid and located closer to the opening than the first rib.

2. The container according to claim 1, wherein the second ribs are provided along an inner side surface of the container main body.

3. The container according to claim 1, wherein, in a cross-sectional shape of the first rib in a direction perpendicular to a longitudinal direction, a side surface closer to the storage portion has a linear shape, and a side surface farther from the storage portion has a curved shape.

4. The container according to claim 1, wherein the second ribs are not provided on an entire circumference of the flange portion.

5. The container according to claim 1, wherein a welded area between the second ribs and the lid is smaller than a welded area between the first rib and the lid.

6. The container according to claim 1,
wherein, when viewed in a direction perpendicular to the surface, a shape of the opening is a substantially rectangular shape that has two long sides, two short sides, and four corners, and
wherein a total number of the first rib and the second ribs included on a straight line perpendicular to a peeling direction of the lid that intersects with the long sides at an angle of 45° is three or less in a range of 90% or more of a distance between two corners located diagonally opposite each other of a substantially rectangular shape in the peeling direction.

7. The container according to claim 1,
wherein, when viewed in a direction perpendicular to the surface, a shape of the opening is a substantially rectangular shape that has two long sides, two short sides, and four corners, and
wherein at least one of the second ribs provided on each of the long side and the short side closest to one of the corners has a length of 7.5 mm or less.

8. The container according to claim 1, wherein the lid is a film.

9. The container according to claim 1, wherein the container main body contains plastic.

10. The container according to claim 1, wherein the container main body contains a recycled plastic material or a resin material mixed with a recycled plastic material.

11. A liquid cartridge container that stores the liquid cartridge in the storage portion of the container according to claim 1.

12. The liquid cartridge container according to claim 11, being configured to store the liquid cartridge that includes a protrusion facing the lid in a state where the liquid cartridge is stored in the storage portion.

13. The liquid cartridge container according to claim 11, being configured to store the liquid cartridge that is a liquid ejection head including an ejection port substrate provided with an ejection port for ejecting liquid.

14. The liquid cartridge container according to claim 11, being configured to store the liquid cartridge that stores ink therein.

15. A container comprising:
a container main body provided with a storage portion including a space and a flange portion configured to form an opening; and
a lid configured to cover the opening,
wherein the flange portion has a surface facing the lid and includes, on the surface,
a first rib configured to be welded to the lid and arranged surrounding the opening, and
a plurality of second ribs configured to be welded to the lid and located closer to the opening than the first rib.

16. A liquid ejection head storage body that stores a liquid ejection head to be attached to a liquid ejection apparatus in the container according to claim 15.

17. A method for manufacturing a liquid cartridge container provided with a liquid cartridge to be attached to a liquid ejection apparatus and a container storing the liquid cartridge,
wherein the container includes a container main body provided with a storage portion including a space in which the liquid cartridge is stored and a flange portion configured to form an opening through which the liquid cartridge is stored in the storage portion, and a lid configured to cover the opening, and
wherein the flange portion has a surface facing the lid and includes, on the surface, a first rib arranged surrounding the opening and a plurality of second ribs located closer to the opening than the first rib,
the method comprising:
storing the liquid cartridge in the storage portion; and
welding the lid to the flange portion via the first rib and the second ribs.

18. The method according to claim 17, further comprising:
collecting the container main body from which the welded lid is peeled off from the container;
storing a second liquid cartridge in the container main body; and
welding a second lid to the flange portion.
